(19) United States
(12) Patent Application Publication
(10) Pub. No.: US 2014/0163218 A1
(43) Pub. Date: Jun. 12, 2014

(54) NOVEL PHTHALOCYANINE DERIVATIVES FOR THERAPEUTIC USE

(71) Applicants: Donata Dei, San Gimignano (IT); Gabrio Roncucci, Poggibonsi (IT); Gianluca Soldaini, Empoli (IT); Daniele Nistri, Lastra a Signa (IT); Giacomo Chiti, Prato (IT); Moira Municchi, Pelago (IT); Lia Fantetti, Firenze (IT); Francesco Giuliani, Prato (IT)

(72) Inventors: Donata Dei, San Gimignano (IT); Gabrio Roncucci, Poggibonsi (IT); Gianluca Soldaini, Empoli (IT); Daniele Nistri, Lastra a Signa (IT); Giacomo Chiti, Prato (IT); Moira Municchi, Pelago (IT); Lia Fantetti, Firenze (IT); Francesco Giuliani, Prato (IT)

(73) Assignee: MOLTENI THERAPEUTICS S.R.L., SCANDICCI (IT)

(21) Appl. No.: 14/236,979

(22) PCT Filed: Aug. 6, 2012
(86) PCT No.: PCT/IB2012/054008

§ 371 Date: Feb. 4, 2014

(30) Foreign Application Priority Data
Aug. 5, 2011 (IT) FI2011A000166

(51) Int. Cl. C07F 7/02

(52) U.S. Cl. CPC C07F 7/025
USPC 540/124; 540/128; 540/127

(57) ABSTRACT

There are described phthalocyanine derivates, the pharmaceutical compositions and the medical devices that contain them, possibly in combination with chelating agents, such as EDTA, useful for treating, by means of photodynamic therapy, diseases characterised by cellular hyperproliferation, microbial infections caused by Gram− bacteria, Gram+ bacteria and fungi, and for treating various types of infected and non-infected ulcers.

### FIELD OF THE INVENTION

The invention relates to the field of photosensitising compounds for therapeutic use.

### STATE OF THE ART

Molecules containing the phthalocyanine chromofluorophore macrocycle are known to produce reactive oxygen species, such as radicals or singlet oxygen and are characterized by a high fluorescence by interaction with visible light.

On account of these properties, phthalocyanine compounds have been used for some time in photodynamic therapy (hereinafter indicated with the abbreviation “PDT”), both for the purposes of therapeutic treatment and for the purposes of diagnostic purposes.

Examples of these compounds are zinc phthalocyanine complexes and the conjugates thereof as described in European patents EP0906758, EP1164135, EP1381611 and EP1883641, which are all in the Applicant's name. These compounds have proven to be effective photosensitising agents in the PDT treatment of both tumours and microbial infections. On the other hand, the described zinc phthalocyanine complexes, while presenting a good solubility in H₂O, which is an essential condition for in vivo bioavailability, present aggregation phenomena in aqueous means, which are easily detected by means of UV-visible spectrophotometric analysis, due to the formation of supramolecular complexes, the formation is which is facilitated by the substantially planar molecular geometry through Van der Walls bonds between the aromatic rings. This aggregation can in turn interfere with the biological effect of the compounds for two main reasons: difficulty entering the target cells on the part of the photosensitisers in aggregate form and inefficient activation on the part of the visible light, with consequent decrease in light absorption and therefore reduction in the efficiency of the photodynamic effect.

Thus many research groups and, in particular, Kenney groups (WO9201753, WO9506688, Photochemistry and Photobiology 1993, 57(2), 242-7, Photochemistry and Photobiology 1997, 65(3), 581-586, Photochemistry and Photobiology 1997, 66(2), 282-287) and Ng groups (Macromolecules 2003, 36(20), 7527-7533, Tetrahedron Letters 2003, 44(43), 8029-8032, Tetrahedron Letters 2005, 46(9), 1551-1554), have been researching silicon phthalocyanine complexes for photodynamic application for many years Hexacoordination of the silicon allows complexing of this semi-metal on the part of the phthalocyanine macrocycle as well as the insertion of axial substituents on the macrocycle itself, thus preventing the vertical approach of the molecules and blocking the hydrophobic interactions that lead to the formation of aggregates.

While the photodynamic action is determined by the aromatic macrocycle, the solubility, the bioavailability and the affinity for target cells, which are determining factors for the development of these molecules as medicines, are strictly linked to the nature of the substituents that are inserted in one of the possible positions of the macrocycle itself.

The insertion of amine or ammonium substituents in axial position is well document in the prior art, above all in the aforementioned Kenney and Ng groups, which are respectively involved in the research of compounds with axial chains of a trialkyllsylyloxy and alchyloxy/aryloxy nature. In particular, the Pc 4 compound reported by Kenney is a known photosensitiser in clinical phase for the treatment of various types of tumours (Journal of Medicinal Chemistry 2004, 47(16), 3897-3915). Notwithstanding the extremely interesting activity, the compound is completely insoluble in aqueous phase and this is of high significance both for the administration of the medicine and for its bioavailability, with objective difficulties for clinical use.

In demonstration thereof, reference must be made to the very recent patent WO2010/108056, wherein water soluble Pc 4 salt formulations are claimed.

On the other part, on checking the properties of the individuals compounds prepared, it is noted that the wording “water soluble” never appears, while reference is made to hydrophobic solvents, such as for example dichloromethane or toluene. The solubility tests of the various compounds in aqueous phase are however recorded in example 4 and provided with three tables of trial data (4, 5, 6), from which there emerges a need to always add a dispersing agent to the aqueous phase. Nevertheless, in this case also, the final concentrations of photosensitiser are very limited (except in rare cases, the range is 0.01-100 micromolar), even if effectively way in excess of those permitted for the non-salified Pc4.

Analogous considerations can be made in relation to that reported by Ng et al in the Journal of Medicinal Chemistry 2011, 54, 320-330, where there are described SiPC conjugates with polyamine, which are theoretically water soluble.

Indeed, compounds 1-9 are described as “quite soluble in water”; it is noted, vice versa, how the stock solutions of photosensitiser to be used for the biological tests were prepared in solvents other than water (THF, MeOH or EtOH). While for low-concentration in vitro experiments, it was sufficient to dilute the starting solution in PBS, in vivo, in order to be able to perform administration of the photosensitiser in the test animals, it was necessary to add 5% of Cremophor EL, a known, non-ionic surfactant, to the formulation. Another fundamental property for a medicine is its stability over time, in particular the constant maintenance of the titre of the active ingredient. The titre may fall both on account of solubility and degradation problems and this should always be avoided for the following reasons: 1) the dosage of a medicine must be defined and be stable over time; 2) precipitation phenomena are of great relevance in terms of efficacy and safety; 3) in the case of chemical degradation, the formation over time of compounds other than the active ingredient is clearly unacceptable.

These aspects are not, vice versa, taken into consideration in the cited prior art. Internal experiments on derivatives of the SiPc classes studied by the above-mentioned authors have demonstrated a tendency to a fall in the titre of the solutions (particularly aqueous solutions), both in terms of precipitation and degradation phenomena (loss of one or of both axial chains), as reported hereunder in the comparison of data relating to the compounds claimed in the present application.

A need has thus emerged to identify photosensitising compounds, which add a greater solubility and stability in aqueous phases to the high activity, which would result in a greater efficacy thereof in photodynamic therapy (PDT) and, above all, in an effective clinical applicability of the drug candidates.

### SUMMARY OF THE INVENTION

There are described phthalocyanine derivates of formula (I), the pharmaceutical compositions and the medical devices that contain them, possibly in combination with chelating agents, such as EDTA, useful for treating, by means of photodynamic therapy, diseases characterized by cellular hyperproliferation, microbial infections caused by Gram− bacteria, Gram+ bacteria and fungi and for treating various types of infected and non-infected ulcers.

### DETAILED DESCRIPTION OF THE INVENTION

The phthalocyanine derivatives of formula (I) therefore are therefore object of the present invention

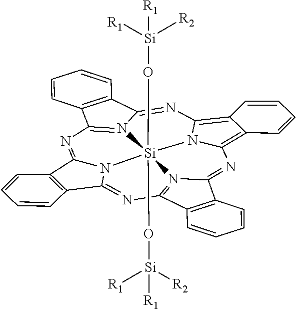

where
R₁=(CH₂)ₙ—CH₃ o X—Y—N⁺R₃R₄R₅;
R₂=(CH₂)ₙ—CH₃ o X₁—Y₁—N⁺R₆R₇R₈;
n=1, 2, 3, 4, 5
X and X₁ equal or different from each other are: phenyl or (CH₂)ₘ where m=1, 2, 3, 4, 5
Y and Y₁ equal or different from each other are:—(O)_{q}—W where W=phenyl or (CH₂)ₚ where q=0, 1 and p=1, 2, 3, 4, 5
R₃ and R₆ equal or different from each other are Me or Et
R₄, R₅, R₇ and R₈ equal or different from each other are Me or Et, or they form a heterocycle selected from morpholine, piperidine, pyridine, pyrimidine, piperazine, pyrrolidine, pyrroline, imidazole and julolidine, with the nitrogen atom to which they are bound.

With the provision that:

R₁ and R₂ cannot be simultaneously (CH₂)ₙ—CH₃

Further object of the invention are the pharmaceutical compositions comprising as active ingredient, and the medical devices containing as main component, a phthalocyanine derivative of formula (I) as described above, possibly in combination with chelating agents, such as EDTA; the use of such derivatives in the preparation of pharmaceutical compositions or of medical devices for the treatment, by means of photodynamic therapy, of diseases characterized by cellular hyperproliferation, of microbial infections caused by Gram− bacteria, Gram+ bacteria and fungi and for the treatment of various types of infected and non-infected ulcers; the process for the preparation of the derivatives of formula (I) The novel intermediate phthalocyanine derivatives of formula (II) are also an object of the invention

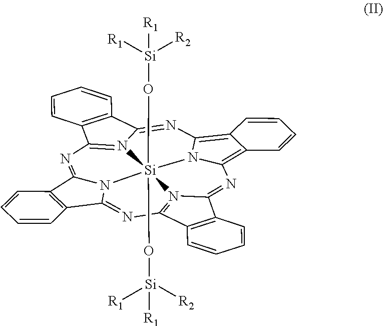

where
R₁=(CH₂)ₙ—CH₃ or X—Y—NR₄R₅;
R₂=(CH₂)ₙ—CH₃ or X₁—Yᵣ—NR₇R₈;
n=1, 2, 3, 4, 5
X and X₁ equal or different from each other are: phenyl or (CH₂)ₘ where m=1, 2, 3, 4, 5
Y and Y₁ equal or different from each other are: —(O)_{q}—W where W=phenyl or (CH₂)ₚ where q=0, 1 and p=1, 2, 3, 4, 5
R₄, R₅, R₇ and R₈ equal or different from each other are Me or Et, or they form a heterocycle selected from morpholine, piperidine, pyridine, pyrimidine, piperazine, pyrrolidine, pyrroline, imidazole and julolidine, with the nitrogen atom to which they are bound.
with the proviion that:
R₁ and R₂ cannot be simultaneously (CH₂)ₙ—CH₃

The compounds of formula (I) are preferred, wherein:

### R₁=X—Y—N⁺R₃R₄R₅

R₂=(CH₂)ₙ—CH₃
and those wherein:

### R₁=X—Y—N⁺R₃R₄R₅

### R₂=X₁—Y₁N⁺R₆R₇R₅

where n, R₁, R₂, R₃R₄, R₅, R₆, R₇, R₈, X, Y, X₁, Y₁ are as defined above. It addition to constituting an original class of compounds from the point of view of the chemical structure, the silicon phthalocyanine complexes of formula (I) present solubility and stability in water that is unexpected based on the prior art. In fact, while it is true that the presence of positive charges naturally leads to an increase of the solubility in water, it was nevertheless unexpected that, compared to amino aliphatic derivatives (certainly protonated in an aqueous means) and, all the more so, to quaternary ammonium derivatives reported in literature, the solubility should be much greater. Even more unexpected was the stabilising effect given to the molecule by the presence of the R₁ and R₂ substituents other than methyl. In fact, and surprisingly, the presence of longer alkyl chains protects, from a steric point of view and/or stabilized from an electronic point of view, the chain between the silicon atom that carried the above-mentioned substituents and the oxygen atom and limits the breakage of the axial chain/s of the phthalocyanine, without compromising the solubility in water of the compounds themselves.

The compounds of formula (I) are prepared starting from commercial products though a multi-step synthesis process consisting of the following main steps (as also shown in Diagram 1 wherein the synthesis of compound 1) is shown by way of example:

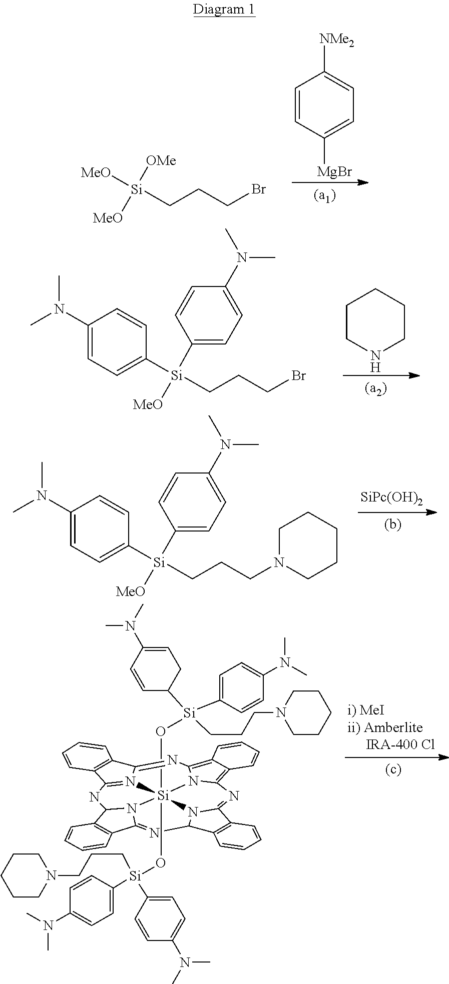

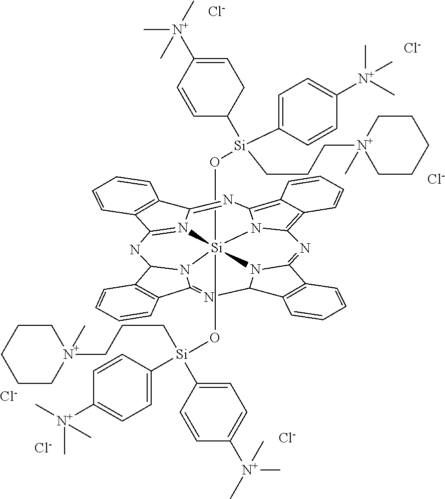

(a) Preparation of the amino group-substituted trialkylmethoxysilane, to be used as a regent for inserting the axial substituents of the phthalocyanine derivative The preparation can envisage multiple concise steps and the amino groups can be inserted through substitution of halogen-terminal groups of alkylsilanes or through the substitution of methoxy groups bound to the silicon atom by Grignard reagents carrying amino-alkyl chains (commercially available or prepared ad hoc).
(b) Insertion of the axial substituents with amino groups on the phthalocyanine nucleus. This step is performed by coupling between a trialkylmethoxysilane and the dihydroxy silicon phthalocyanine.
(c) Quaternarization of each amino substituent by means of a treatment with alkylating agents and ion exchange to give the final quaternary ammonium salt in the form of chloride.

The following examples of preparation (examples 1-5), of characterisation in terms of solubility (example 6) and stability (example 7) in aqueous solution and of photodynamic activity (example 8) of the compounds of formula (I), are provided by way of a non-limiting illustration of the present invention.

### Example I

### Synthesis of {bis-[bis-(p-N,N,N-trimethylammoniumphenyl)]-3-(N-methyl-piperidine-1-ium)propylsilyloxy}silicon(IV) phthalocyanine hexachloride (Compound 1)

### a1) Synthesis of bis-(p-N,N-dimethylaminophenyl)-3-bromopropylmethoxy silane

To a solution of 3-bromopropylmethoxy silane (365 mg, 1.5 mmol) in anhydrous tetrahydrofuran (8 mL) are added, in an inert atmosphere, 12 mL of a solution 0.5 M of 4-N,N-dimethylaminophenyl magnesium chloride (6 mmol). The solution is agitated at 90° C. for 2.5 hours. The reaction mixture is diluted with 200 mL of ethyl ether and filtered through celite. 960 mg of raw product are obtained following evaporation of the solvent. The product was characterized by means of ¹H-NMR analysis.

¹H-NMR (300 MHz, DMSO-d₆): 7.30-6.59 (m, 8H), 3.49 (t, 2H, J=7.0 Hz), 3.52 (s, 3H), 2.88 (s, 12H), 1.76 (m, 2H), 1.08 (m, 2H).

### a2) Synthesis of bis-(p-N,N-dimethylaminophenyl)-3-(piperidine-1-yl)propylmethoxy silane

To a solution of 900 mg of raw bis-(p-N,N-dimethylaminophenyl)-3-bromopropylmethoxy silane (1.4 theoretical mmol) in MeOH (4 mL) are added 60 mg of potassium carbonate (0.45 mmol) and 380 mg of piperidine (4.5 mmol). The reaction mixture is agitated at 90° C. for 1.5 hours, is then allowed to return to room temperature, and is diluted with 150 mL of ethyl ether. The precipitate is filtered through celite and 750 mg of raw intermediate are obtained following evaporation of the solvent. The product was characterized by means of ¹H-NMR analysis.

¹H-NMR (300 MHz, DMSO-d₆): 7.32-6.61 (m, 8H), 3.62 (s, 3H), 2.88 (s, 12H), 2.20 (m, 6H), 1.43 (m, 8H), 0.95 (m, 2H).

### b) Synthesis of {bis-[bis-(p-N,N-dimethylaminophenyl)]-3-(piperidine-1-yl)propylsilyloxy}silicon(IV) phthalocyanine

In a round-bottomed, two-necked 100 mL flask, a mixture of dihydroxy silicon phthalocyanine (140 mg, 0.25 mmoL) in 2-ethylpyridine (10 mL) is agitated under reflux and a 0.1 M solution in 2-ethylpyridine of raw bis-(p-dimethylaminophenyl)-3-(piperidine-1-yl)propylmethoxy silane (750 mg, 1.4 theoretical mmol), obtained as described in point a2), is added, drop by drop by means of a dropping funnel, over 3 hours. After 4 hours of the start of the reaction the solution is allowed to return to room temperature and the solvent evaporates. The raw product thus obtained is washed with hexane (2×20 mL) and purified by chromatography on silica gel (mobile phase: dichloromethane/dimethylformamide 5/1→5/1+1% triethylamine). After having evaporated the solvent of the fractions collected, the product is dissolved in 7 mL of dichloromethane and re-precipitated by adding 42 mL of petroleum ether. Following filtering and drying, 165 mg (0.12 mmol, 48% yield) of product are obtained as a blue solid.

The product was characterized by means of ¹H-NMR analysis.

¹H-NMR (300 MHz, CDCl3): 9.49 (m, 8H), 8.26 (m, 8H), 5.64 (m, 8H), 4.65 (m, 8H), 2.67 (s, 24H), 1.70 (m, 12H), 1.36 (m, 8H), 1.06 (m, 4H), −1.05 (m, 4H), −1.97 (m, 4H).

### c) Synthesis of {bis-[bis-(p-N,N,N-trimethylammoniumphenyl)]-3-(N-piperidine-1-ium)propylsilyloxy}silicon(IV) phthalocyanine hexachloride

To a solution of 140 mg (0.1 mmol) of {bis-[bis-(p-N,N-dimethylaminophenyl)]-3-(piperidine-1-yl)propylsilyloxy]}silicon(IV) phthalocyanine, obtained as described in point b), 0.4 mL of methyl iodide (6.8 mmol) are added in 8 mL of N-methylpyrrolidone (NMP), The solution is agitated at room temperature and away from light for 48 hours. The reaction mixture is diluted with 8 mL of methanol and is then treated with 90 mL of ethyl ether. The suspension obtained is allowed to mix for 10 minutes and to rest for 30 minutes, is then filtered and the solid washed with ethyl ether (2×50 mL). There were obtained 180 mg of wet product, utilised as is for the subsequent step.

This product was characterized by means of ¹H-NMR analysis.

¹H-NMR (300 MHz, DMSO-d₆): 9.64 (m, 8H), 8.59 (m, 8H), 6.99 (m, 8H), 4.89 (m, 8H), 3.39 (s, 36H), 2.73 (m, 4H), 2.53 (m, 4H), 2.32 (s, 6H), 2.08 (m, 4H), 1.52-1.27 (m, 12H), −1.04 (m, 4H), −1.67 (m, 4H). 160 mg of {bis-[bis-(p-N,N,N-trimethylammoniumhenyl)]-3-(N-methyl-piperidine-1-ium)propylsilyloxy}silicon(IV) phthalocyanine hexachloride are dissolved in 6 mL of methanol. The solution is subjected to ionic exchange with 9 g of Amberlite® IRA 400 (CI) resin, preventively washed with water and conditioned with methanol. 60 mL of ethyl ether are slowly added to the eluate, which is kept under agitation. The desired product is recovered for centrifugation of the suspension obtained La and washed with ethyl ether (2×10 mL). There are obtained 128 mg of compound 1 (0.08 mmol, 76% yield) characterized as follows:

¹H-NMR (300 MHz, DMSO-d₆): 9.64 (m, 8H), 8.59 (m, 8H), 6.99 (m, 8H), 4.89 (m, 8H), 3.39 (s, 36H), 2.73 (m, 4H), 2.53 (m, 4H), 2.32 (s, 6H), 2.08 (m, 4H), 1.52-1.27 (m, 12H), −1.04 (m, 4H), −1.67 (m, 4H).

¹³C-NMR (75 MHz, DMSO-d₆): δ=148.4, 147.5, 135.2, 134.6, 132.9, 132.6, 123.9, 118.6, 63.7, 59.4, 56.1, 45.9, 20.3, 18.9, 13.0, 7.6.

UV-vis (H₂O) λₘₐₓ(%): 694 (100), 624 (15), 359 (37).

ESI-MS: m/z 242 [(M-6 Cl⁻)⁶⁺]

HPLC purity: 90.8%

### Example II

### Synthesis of {bis-[bis-(3-N,N,N-trimethylammoniumpropyl)]propylsilyloxy}silicon(IV) phthalocyanine tetrachloride (compound 2)

### a1) Synthesis of 3-N,N-dimethylaminopropyl magnesium chloride

380 mg (48 mmol) of lithium hydride are added to a solution of 3-chlorine-N,N,-dimethylpropylamine hydrochloride (3.8 g, 24 mmol) in 25 mL of anhydrous tetrahydrofuran. The mixture is agitated at room temperature for 1 hour, following which agitation is stopped and the solid is allowed to settle. Into a round-bottomed, two-necked flask containing 690 mg (29 mmol) of magnesium turnings and 2.0 g (48 mmol) of lithium chloride and dried with vacuum-nitrogen cycles, are added in an inert atmosphere, 12 mL of anhydrous tetrahydrofuran, 0.7 mL of a 1M solution in tetrahydrofuran of diisobutylalluminium hydride and the amine solution, drop by drop. On completion of the addition, the mixture is agitated under reflux for 4 hours. When the reaction mixture is brought back to room temperature, Grignard titration is carried out while following the procedure as set out hereunder.

Into a round-bottomed, dried vacuum flask are loaded 64 mg of iodine (0.25 mmol) and 2 mL of a 0.5 M solution of lithium chloride in anhydrous tetrahydrofuran. The Grignard solution is added to the solution drop by drop until disappearance of the brown colouration is observed. The Grignard titre, prepared according to the reported procedure is 0.625 M.

### a2) Synthesis of bis-(3-N,N-dimethylaminopropyl)methoxypropyl silane

Into a round-bottomed, two-necked dried vacuum flask are added 510 mg of propyltrimethoxy silane (3.1 mmol) and 20 mL of the 0.625 M solution in tetrahydrofuran of 3-N,N-dimethylaminopropyl magnesium chloride (12.4 mmol). The solution is agitated at 55° C. for 3 hours, after which is diluted with 150 mL of ethyl ether. The suspension is filtered through celite and 840 mg of raw material are obtained following evaporation of the solvent.

¹H-NMR (300 MHz, DMSO-d₆): 3.33 (s, 3H), 2.14 (t, 4H, J=7.1 Hz), 2.07 (s, 12H), 1.43-1.28 (m, 6H), 0.92 (t, 3H, J=7.1 Hz), 0.58-0.50 (m, 6H).

### b) Synthesis of {bis-[bis-(3-N,N-dimethylaminopropyl)]propylsilyloxy}silicon(IV) phthalocyanine

In a round-bottomed, two-necked 100 mL flask, a mixture of 430 mg of dihydroxy silicon phthalocyanine (0.76 mmol) in 2-ethylpyridine (20 mL) is agitated under reflux and a 0.1 M solution in 2-ethylpyridube of raw bis-(3-N,N-dimethylaminopropyl)methoxypropyl silane (830 mg, 3.0 theoretical mmol), obtained as described in point a2), is added, drop by drop by means of a dropping funnel, over 2 hours. After 4 hours of the start of the reaction the solution is left to return to room temperature and the solvent evaporates. The raw product obtained is dissolved in 20 mL of ethanol and re-precipitated by adding 100 mL of water. The solid is filtered, washed with water and vacuum dried. The raw product is purified by chromatography on silica gel (mobile phase: ethyl acetate/dimethylformamide 3/1→2/1+1% triethylamine). After having evaporated the solvent of the fractions collected, the product is dissolved in 8 mL of ethanol and re-precipitated by adding 40 mL of water. Following filtering and drying, 540 mg (0.51 mmol, 67% yield) of product are obtained as a blue solid. The product was characterized by means of ¹H-NMR analysis.

¹H-NMR (300 MHz, CD₃OD-d₄): 9.69 (m, 8H), 8.45 (m, 8H), 1.73 (s, 24H), 1.03 (dd, 8H, J=7.9, 7.7 Hz), −0.23 (t, 6H, J=7.1 Hz), −1.00 (m, 12H), −2.39 (m, 12H).

### c) Synthesis of {bis-[bis-(3-N,N,N-trimethylammoniumpropyl)]propylsilyloxy}silicon(IV) phthalocyanine tetrachloride

To a solution of 160 mg (0.15 mmol) of {bis-[bis-(3-N,N-dimethylaminopropyl)]propylsilyloxy}silicon(IV) phthalocyanine, obtained as described in point b), 0.4 mmol of methyl iodide (6.4 mmol) are added in 10 mL of N-methylpyrrolidone (NMP). The solution is agitated at room temperature and away from light for 72 hours. The reaction mixture is diluted with 10 mL of methanol and is then treated with 120 mL of ethyl ether. The suspension obtained is left to mix for 10 minutes and to rest for 30 minutes, is then filtered and the solid washed with ethyl ether (2×50 mL). There are obtained 230 mg of wet product, utilised as is for the subsequent step.

This product was characterized by means of ¹H-NMR analysis.

¹H-NMR (300 MHz, DMSO-d₆): 9.71 (m, 8H), 8.56 (m, 8H), 2.48 (s, 36H), 1.99 (m, 8H), −0.34 (m, 6H), −0.89 (m, 8H), −1.23 (m, 4H), −2.35 (m, 4H), −2.51 (m, 8H). 220 mg of {bis-[bis-(3-N,N,N-trimethylammoniumpropyl)]propylsilyloxy}silicon(IV) phthalocyanine tetraiodide are dissolved in 11 mL of a 10/1 methanol/dimethylformamide mixture. The solution is subjected to ionic exchange with 10 g of Amberlite® IRA 400 (CI) resin, preventively washed with water and conditioned with methanol. 100 mL of ethyl ether are slowly added to the eluate, which is kept under agitation. The desired product is recovered for centrifugation of the suspension obtained and washed with ethyl ether (2×15 mL). There are obtained 155 mg of compound 2 (0.12 mmol, 82% yield) characterized as follows:

¹H-NMR (300 MHz, DMSO-d₆): 9.72 (m, 8H), 8.54 (m, 8H), 2.53 (s, 36H), 2.04 (m, 8H), −0.34 (m, 6H), −0.84 (m, 8H), −1.20 (m, 4H), −2.36 (m, 4H), −2.48 (m, 8H).

¹³C-NMR (75 MHz, DMSO-d₆): δ=149.1, 135.6, 133.1, 124.5, 67.3, 52.2, 17.6, 15.2, 14.9, 14.8, 8.5.

UV-vis (H₂O) λₘₐₓ(%): 677 (100), 610 (15), 350 (34).

ESI-MS: m/z 280 [(M-4Cl⁻)⁴⁺].

HPLC purity: 98.7%

### Example III

### Synthesis of {bis-[bis-(p-N,N,N-trimethylammoniumphenyl)]propylsilyloxy}silicon(IV) phthalocyanine tetrachloride (compound 3)

### a) Synthesis of bis-(p-N,N-dimethylaminophenyl)methoxypropyl silane

Into a round-bottomed, two-necked dried vacuum flask are added, in an inert atmosphere, 205 mg of propyltrimethoxy silane (1.25 mmol) and 10 mL of a 0.5 M solution in tetrahydrofuran of 4-N,N-dimethylaminophenyl magnesium chloride (5 mmol). The solution is agitated at 90° C. for 2 hours. The reaction mixture is diluted with 150 mL of ethyl ether and filtered through celite. 450 mg of raw product are obtained following evaporation of the solvent. The product was characterized by means of ¹H-NMR analysis.

¹H-NMR (300 MHz, DMSO-d₆): 7.28 (m, 4H), 6.70 (m, 4H), 3.39 (s, 3H), 2.86 (s, 12H), 1.29 (m, 2H), 0.99-0.82 (m, 5H).

### b) Synthesis of {bis-[bis-(p-N,N-dimethylaminophenyl)]propylsilyloxy}silicon(IV) phthalocyanine

In a round-bottomed, two-necked 100 mL flask, a mixture of 114 mg of dihydroxy silicon phthalocyanine (0.2 mmol) in 2-ethylpyridine (8 mL) is agitated under reflux and a 0.1 M solution in 2-ethylpyridine of raw bis-(p-N,N-dimethylaminophenyl)methoxypropyl silane (430 mg, 1.22 theoretical mmol), obtained as described in point a), is added, drop by drop by means of a dropping funnel, over 2 hours. After 3 hours of the start of the reaction the solution is allowed to return to room temperature and the solvent evaporates. The raw product obtained is washed with petroleum ether (2×20 mL) that has been dried and purified by chromatography on silica gel (petroleum ether/mixture A 70/30, where mixture A comprises dichloromethane/tetrahydrofuran/methanol 94/5/1). After having evaporated the solvent of the fractions collected, 51 mg of the product (0.043 mmol, 21% yield) are obtained as a blue solid. The product was characterized by means of ¹H-NMR analysis.

¹H-NMR (300 MHz, CDCl₃): 9.49 (m, 8H), 8.25 (m, 8H), 5.65 (m, 8H), 4.67 (m, 8H), 2.68 (s, 24H), −0.30 (m, 6H), −1.30 (m, 4H), −1.96 (m, 4H).

### c) Synthesis of {bis-[bis-(p-N,N,N-trimethylammoniumphenyl)]propylsilyloxy}silicon(IV) phthalocyanine tetrachloride

To a solution of 40 mg (0.15 mmol) of {bis-[bis-(p-N,N-dimethylaminophenyl)]propylsilyloxy}silicon(IV) phthalocyanine, obtained as described in point b), 0.1 mmol of methyl iodide (1.5 mmol) are added in 4 mL of N-methylpyrrolidone (NMP). The solution is agitated at room temperature and away from light for 48 hours. The reaction mixture is diluted with 4 mL of methanol and is then treated with 35 mL of ethyl ether. The suspension obtained is left to mix for 10 minutes and to rest for 30 minutes, is then filtered and the solid washed with ethyl ether (2×50 mL). There are obtained 83 mg of wet product, utilised as is for the subsequent step.

This product was characterized by means of ¹H-NMR analysis.

¹H-NMR (300 MHz, DMSO-d₆): 9.61 (m, 8H), 8.56 (m, 8H), 6.89 (m, 8H), 4.81 (m, 8H), 3.30 (s, 36H), −0.34 (m, 6H), −1.59 (m, 4H), −1.71 (m, 4H).

80 mg of {bis-[bis-(p-N,N,N-trimethylammoniumphenyl)]propylsilyloxy}silicon(IV) phthalocyanine tetraiodide are dissolved in 5 mL of methanol. The solution is subjected to ionic exchange with 6 g of Amberlite® IRA 400 (CI) resin, preventively washed with water and conditioned with methanol. 40 mL of ethyl ether are slowly added to the eluate, which is kept under agitation. The desired product is recovered for centrifugation of the suspension obtained and washed with ethyl ether (2×10 mL). After drying, the solid is dissolved in 3 mL of methanol and re-precipitated by adding 20 mL of ethyl ether. After centrifuging and drying there are obtained 41 mg of compound 3 (0.03 mmol, 90% yield), characterized as follows:

¹H-NMR (300 MHz, DMSO-d₆): 9.62 (m, 8H), 8.55 (m, 8H), 6.94 (m, 8H), 4.81 (m, 8H), 3.34 (s, 36H), −0.34 (m, 6H), −1.58 (m, 4H), −1.71 (m, 4H).

¹³C-NMR (75 MHz, DMSO-d₆): 6=148.4, 147.3, 136.3, 134.8, 132.6, 132.3, 123.7, 118.4, 56.0, 16.4, 14.0, 13.1.

UV-vis (MeOH/H₂O 50/50) λₘₐₓ(%): 692 (100), 622 (15), 358 (37).

ESI-MS: m/z 314 [(M-4Cl⁻)⁴⁺].

HPLC purity: 83.2%

### Example IV

### Synthesis of {bis-[3-(N-methyl-piperidin-1-ium)propyl-dipropvlsilyloxy]}silicon(IV) phthalocyanine dichloride: (compound 4)

### a1) Synthesis of (3-bromopropyl)dipropylmethoxy silane

To a solution of 3-bromopropylmethoxy silane (730 mg, 3 mmol) in anhydrous tetrahydrofuran (16 mL) are added, in an inert atmosphere, 3.8 mL of a 2 M solution of tetrahydrofuran of propyl magnesium chloride (7.5 mmol). The solution is agitated at 60° C. for 2.5 hours. The reaction mixture is diluted with 100 mL of petroleum ether and filtered through celite. 760 mg of raw product are obtained (2.8 mmol, 93% yield). The product was characterized by means of ¹H-NMR analysis.

¹H-NMR (300 MHz, DMSO-d₆): 3.49 (t, 2H, J=6.8 Hz), 3.34 (s, 3H), 1.78 (m, 2H), 1.32 (m, 4H), 0.92 (t, 6H, J=7.3 Hz), 0.67 (m, 2H), 0.57 (m, 4H).

### a2) Synthesis of [3-(piperidine-1-yl)propyl]dipropylmethoxy silane

To a solution of raw (3-bromopropyl)dipropylmethoxy silane (760 mg, 2.8 mmol) in MeOH (5 mL) are added the potassium carbonate (150 mg, 1.1 mmol) and the piperidine (950 mg, 11.2 mmol). The reaction mixture is agitated at 90° C. for 1.5 hours, is then allowed to return to room temperature, and is diluted with 200 mL of ethyl ether. The precipitate is filtered through celite and 757 mg of raw intermediate are obtained following evaporation of the solvent. The product was characterized by means of ¹H-NMR analysis.

¹H-NMR (300 MHz, DMSO-d₆): 3.32 (s, 3H), 2.25 (m, 4H), 2.17 (t, 2H, J=7.4 Hz), 1.45-1.27 (m, 12H), 0.91 (t, 6H, J=7.0 Hz), 0.54 (m, 4H).

### Synthesis of {bis-[3-(piperidin-1-yl)propyl-dipropvlsilvloxy]}silicon(IV) phthalocyanine

In a round-bottomed, two-necked 50 mL flask, a mixture of dihydroxy silicon phthalocyanine (130 mg, 0.23 mmoL) in 2-ethylpyridine (10 mL) is agitated under reflux and a 0.1 M solution in 2-ethylpyridine of raw (3-(piperidine-1-yl)propylmethoxy silane (380 mg, 1.4 theoretical mmol), obtained as described in point a2), is added, drop by drop by means of a dropping funnel, over 1 hour. After 2.5 hours of the start of the reaction the solution is left to return to room temperature and the solvent evaporates. The raw product obtained is dissolved in 40 mL of an ethanol/butanol 2/1 mixture and re-precipitated by adding 50 mL of water. The solid is filtered, washed with water and vacuum dried. The raw product is purified by chromatography on silica gel (mobile phase: chloroform/dimethylformamide 10/1→5/1). After having evaporated the solvent of the fractions collected there are obtained 165 mg of product (0.157 mmol, 69 yield), as a blue solid. The product was characterized by means of ¹H-NMR analysis.

¹H-NMR (300 MHz, CDCl3): 9.64 (m, 8H), 8.34 (m, 8H), 1.90 (m, 8H), 1.50 (m, 8H), 1.42 (m, 4H), 1.11 (m, 4H), −0.29 (t, 12H, J=7.2 Hz), −1.02-1.20 (m, 12H), −2.45 (m, 12H).

### c) Synthesis of {bis-[3-(N-methyl-piperidin-1-ium)propyl-dipropylsilyloxy]}silicon(IV) phthalocyanine dichloride

To a solution of 70 mg (0.07 mmol) of {bis-[3-(piperidine-1-yl)propyl-dipropylsilyloxy]}silicon(IV) phthalocyanine, obtained as described in point b), 0.1 mmol of methyl iodide (1.5 mmol) are added in 5 mL of N-methylpyrrolidone (NMP). The solution is agitated at room temperature and away from light for 24 hours. The reaction mixture is diluted with 5 mL of methanol and is then treated with 70 mL of ethyl ether. The suspension obtained is left to mix for 10 minutes and to rest for 30 minutes, is then filtered and the solid washed with ethyl ether (2×50 mL). There were obtained 65 mg of wet product, utilises as is for the subsequent step.

This product was characterized by means of ¹H-NMR analysis.

¹H-NMR (300 MHz, DMSO-d₆): 9.69 (m, 8H), 8.52 (m, 8H), 2.71 (m, 4H), 2.58 (m, 4H), 2.36 (s, 6H), 2.02 (m, 4H), 1.59-1.31 (m, 12H), −0.35 (t, 12H, J=7.2 Hz), −1.09 (m, 8H), −1.27 (m, 4H), −2.39 (m, 8H), −2.56 (m, 4H).

60 mg of {bis-[3-N-methyl-piperidine-1-ium)propyl-dipropylsilyloxy}silicon(IV) phthalocyanine di-iodide are dissolved in 6 mL of a 10/1 methanol/dimethylformamide mixture. The solution is subjected to ionic exchange with 7 g of Amberlite® IRA 400 (CI) resin, preventively washed with water and conditioned with methanol. 80 mL of ethyl ether are slowly added to the eluate, which is kept under agitation. The desired product is recovered for centrifugation of the suspension obtained and washed with ethyl ether (2×10 mL). After drying there are obtained 53 mg of compound 4 (0.05 mmol, 70% yield), characterized as follows:

¹H-NMR (300 MHz, DMSO-d₆): 9.69 (m, 8H), 8.53 (m, 8H), 2.72 (m, 4H), 2.62 (m, 4H), 2.37 (s, 6H), 2.03 (m, 4H), 1.60-1.31 (m, 12H), −0.35 (t, 12H, J=7.2 Hz), −1.09 (m, 8H), −1.26 (m, 4H), −2.38 (m, 8H), −2.56 (m, 4H).

¹³C-NMR (75 MHz, DMSO-d₆): δ=148.3, 147.5, 135.0, 131.9, 64.5, 59.4, 45.7, 20.4, 18.9, 16.8, 14.8, 14.1, 13.0, 8.2.

UV-vis (MeOH/H₂O 50/50) λₘₐₓ(%): 689 (100), 623 (15), 356 (33).

ESI-MS: m/z 541 [(M-2Cl⁻)²⁺].

HPLC purity: 99.6%

### Example V

### Synthesis of {bis-[3-(m-N,N,N-trimethylammoniumphenyloxy)propyl-dipropylsilyloxyl]}silicon(IV) phthalocyanine dichloride: (compound 5)

### a1) Synthesis of 3-(m-N,N-dimethylaminophenyloxy)propyl-trimethoxy silane

In a round-bottomed, two-necked flask, 160 mg of trimethoxysilane (1.7 mmol) and 0.16 mL of a solution at 3% in toluene of the catalyser of Karsted (Pt(0) are added, in an inert atmosphere, to a solution of N,N-dimethyl-3-allyl-aniline (250 mg, 1.4 mmol) in anhydrous tetrahydrofuran (10 mL). The solution is agitated under reflux for 3 hours. 430 mg of the raw product are obtained following evaporation of the solvent. The product was characterized by means of ¹H-NMR analysis.

¹H-NMR (300 MHz, DMSO-d₆): 7.02 (m, 1H), 6.29-6.17 (m, 3H), 3.86 (t, 2H, J=6.6 Hz), 3.46 (s, 9H), 2.84 (s, 6H), 1.71 (m, 2H), 0.69 (m, 2H).

### a2) Synthesis of 3-(m-N,N-dimethvlaminophenyloxy)propyl-dipropylmethoxy silane

To a solution of raw 3-(m-N,N-dimethylaminophenyloxy)propyl-trimethoxy silane (420 mg, 1.4 theoretical mmol) in anhydrous tetrahydrofuran (10 mL) are added, in an inert atmosphere, 2.8 mL of a 2 M solution of tetrahydrofuran of propyl magnesium chloride (5.6 mmol). The solution is agitated at 60° C. for 4 hours. The reaction mixture is diluted with 100 mL of ethyl ether and filtered through celite. 370 mg of raw product are obtained (1.1 mmol, 80% yield). The product was characterized by means of ¹H-NMR analysis.

¹H-NMR (300 MHz, DMSO-d₆): 7.02 (m, 1H), 6.28-6.17 (m, 3H), 3.86 (m, 2H), 3.34 (s, 3H), 2.84 (s, 6H), 1.67 (m, 2H), 1.34 (m, 4H), 0.92 (t, 6H, J=7.2 Hz), 0.65 (m, 2H), 0.58 (m, 4H).

### b) Synthesis of {bis-[3-(m-N,N-dimethylaminophenyloxy)propyl-dipropylsilyloxy]}silicon(IV) phthalocyanine

In a round-bottomed, two-necked 50 mL flask, a mixture of dihydroxy silicon phthalocyanine (100 mg, 0.18 mmoL) in 2-ethylpyridine (9 mL) is agitated under reflux and a 0.1 M solution in 2-ethylpyridine of raw (3-(m-N,N-dimethylaminophenyloxy)propyl-dipropylmethoxy silane (360 mg, 1.1 theoretical mmol), obtained as described in point a2), is added, drop by drop by means of a dropping funnel, over 1 hour. After 4 hours of the start of the reaction the solution is left to return to room temperature and the solvent evaporates. The raw product is purified by chromatography on silica gel (mobile phase: dichloromethane/petroleum ether 3/1→15/1). After having evaporated the solvent of the fractions collected, the solid is washed with petroleum ether (2×15 mL) and 40 mg of product (0.04 mmol, 19% yield) are obtained as a blue solid. The product was characterized by means of ¹H-NMR analysis.

¹H-NMR (300 MHz, CDCl₃): 9.62 (m, 8H), 8.28 (m, 8H), 7.07 (m, 2H), 6.31 (m, 2H), 5.88-5.85 (m, 4H), 2.91 (s, 12H), 2.58 (t, 4H, 7.0 Hz), −0.31 (t, 12H, 7.2 Hz), −0.74 (m, 4H), −1.13 (m, 8H), −2.32-2.41 (m, 12H).

### c) Synthesis of {bis-[3-(m-N,N,N-trimethylammoniumphenyloxy)propyl-dipropylsilyloxy]}silicon(IV) phthalocyanine dichloride

To a solution of 35 mg (0.03 mmol) of {bis-[3-(m-N,N-dimethylaminophenyloxy)propyl-dipropylsylyloxy]}silicon(IV) phthalocyanine, obtained as described in point b), 0.5 mmol of methyl iodide (0.7 mmol) are added in 2.5 mL of N-methylpyrrolidone (NMP). The solution is agitated at room temperature and away from light for 24 hours. The reaction mixture is diluted with 3 mL of methanol and is then treated with 30 mL of ethyl ether. The suspension obtained is left to mix for 10 minutes and to rest for 30 minutes, is then centrifuged and the solid washed with ethyl ether (2×10 mL). There are obtained 24 mg of wet product, utilises as is for the subsequent step.

24 mg of {bis-[3-(m-N,N,N-trimethylammoniumphenyloxy)propyl-dipropylsilyloxy]}silicon(IV) phthalocyanine di-iodide are dissolved in 2 mL of methanol. The solution is subjected to ionic exchange with 4 g of Amberlite® IRA 400 (CI) resin, preventively washed with water and conditioned with methanol. 40 mL of ethyl ether are slowly added to the eluate, which is kept under agitation. The desired product is recovered for centrifugation of the suspension obtained and washed with ethyl ether (2×10 mL). There are obtained 20 mg of compound 5 (0.02 mmol, 53% yield) characterized as follows:

¹H-NMR (300 MHz, DMSO-d₆): 9.64 (m, 8H), 8.42 (m, 8H), 7.52-7.39 (m, 4H), 7.00 (m, 2H), 6.61 (m, 2H), 3.51 (s, 18H), 2.60 (t, 4H, J=6.8 Hz), −0.39 (t, 12H, J=7.1 Hz), −0.86 (m, 4H), −1.21 (m, 8H), −2.32 (m, 4H), −2.45 (m, 8H). ¹³C-NMR (75 MHz, DMSO-d₆): 6=158.9, 148.3, 148.0, 135.1, 131.6, 130.6, 123.3, 115.1, 111.6, 107.1, 69.5, 56.3, 20.5, 16.8, 15.0, 14.2, 7.9.

UV-vis (MeOH/H₂O 50/50) λₘₐₓ(%): 691 (100), 624 (30), 359 (51).

### ESI-MS: m/z 593 [(M-2Cl⁻)²⁺].

HPLC purity: 99.5%

The following compounds were also prepared in accordance with the procedure set out in examples I-V:
{bis-[bis-2-(N,N-dimethyl-pyrrolidin-2-ium)ethyl]propylsilyloxy}silicon(IV) phthalocyanine tetrachloride (compound 6):

UV-vis (MeOH/H₂O 50/50) λₘₐₓ (100%): 690 ESI-MS: m/z 306 [(M-4Cl⁻)⁴⁺]
{bis-[bis-2-(N, N-dimethyl-pyrrolidin-2-ium)ethyl]ethylsilyloxy}silicon(IV) phthalocyanine tetrachloride (compound 7):

UV-vis (MeOH/H₂O 50/50) λₘₐₓ(100%)): 691 ESI-MS: m/z 299 [(M-4Cl⁻)⁴⁺]
{bis-[bis-(N,N-dimethyl-piperidin-3-ium)methyl]propylsilyloxy}silicon(IV) phthalocyanine tetrachloride (compound 8):

UV-vis (MeOH/H₂O 50/50) λₘₐₓ(100%): 690 ESI-MS: m/z 306 [(M-4Cl⁻)⁴⁺]
{bis-[bis-3-(N-methyl-piperidin-1-ium)propyl]propylsilyloxy}silicon(IV) phthalocyanine tetrachloride (compound 9):

UV-vis (MeOH/H₂O 50/50) λₘₐₓ(100%): 689 ESI-MS: m/z 320 [(M-4Cl⁻)⁴⁺]
{bis-[bis-3-(N-methyl-piperidin-1-ium)propyllbutylsilyloxy}silicon(IV) phthalocyanine tetrachloride (compound 10):

UV-vis (MeOH/H₂O 50/50) λₘₐₓ(100%): 690 ESI-MS: m/z 327 [(M-4Cl⁻)⁴⁺]
{bis-[bis-2-(N-methyl-pyrrolidin-1-ium)ethyllpropylsilyloxy}silicon(IV) phthalocyanine tetrachloride (compound 11);

UV-vis (MeOH/H₂O 50/50) λₘₐₓ(100%): 689 ESI-MS: m/z 295 [(M-4Cl⁻)⁴⁺]
{bis-[bis-2-(N-methyl-pyrrolidin-1-ium)ethyl]ethylsilyloxy}silicon(IV) phthalocyanine tetrachloride (compound 12);

UV-vis (MeOH/H₂O 50/50) 2ₘₐₓ(100%): 688 ESI-MS: m/z 288 [(M-4Cl⁻)⁴⁺]
{bis-[bis-(p-N,N,N-trimethylammoniumphenyl)]-2-(N,N-dimethyl-pyrrolidin-2-ium)ethylsilyloxy}silicon(IV) phthalocyanine hexachloride (compound 13);

UV-vis (MeOH/H₂O 50/50) λₘₐₓ (100%): 693 ESI-MS: m/z 238 [(M-6Cl⁻)⁶⁺]
{bis-[bis-(p-N,N,N-trimethylammoniumphenyl)]-(N,N-dimethyl-piperidin-3-ium)methylsilyloxy}silicon(IV) phthalocyanine hexachloride (compound 14);

UV-vis (MeOH/H₂O 50/50) λₘₐₓ (100%): 694 ESI-MS: m/z 238 [(M-6Cl⁻)⁶⁺]

### Example VI

### Evaluation of the Solubility in Water of the Compounds of Formula (I), without Addition of Dispersing Agents

Protocol: each compound is dissolved in water at the concentration of 1 mg/mL; the mixture is subjected to ultrasound for a few minutes and is then centrifuged at 4000 revolutions/min for 4 min. In the absence of precipitate, the compound is deemed soluble at the concentration indicated. In the event of precipitation, the necessary water for achieving a double dilution is added and the solubility of the compound at that concentration is assessed. The dilutions are continued until the absence of precipitation. The results obtained in relation to compounds 1-5 are shown in table I

TABLE I
Solubility of compounds 1-5 in deionised water

| | Concentration of the compound in deionised water | | | |
|---|---|---|---|---|
| | 1.0 mg/mL | 0.5 mg/mL | 0.25 mg/mL | 0.12 mg/mL |
| Compound | (mmol/L) | (mmol/L) | (mmol/L) | (mmol/L) |
| 1 | soluble (0.6) | soluble | soluble | soluble |
| 2 | soluble (0.8) | soluble | soluble | soluble |
| 3 | soluble (0.7) | soluble | soluble | soluble |
| 4 | precipitate | soluble (0.4) | soluble | soluble |
| 5 | precipitate | precipitate | precipitate | soluble (0.1) |

All compounds 1-5 are soluble in water alone at concentrations useful for therapeutic use.

### Example VII

### Evaluation of the Stability in Water of the Compounds of Formula (I), in Comparison with Derivatives Belonging to Other Classes (Kenney-Like and Ng-Like)

Protocol: each sample is dissolved in DMSO at the concentration of 1 mg/mL and then diluted 1:10 with deionised water. The solution is analysed in HPLC at time 0 and after 8 hours and any loss of titre and/or of purity is recorded by the following method: Column: Luna C18 (2) 150*4.6 mm (5 μm);

elution in gradient of AcOH 0.1% in water (Eluent A) and methanol (Eluent B) with % B 10-100 in 20 min or 40-100 depending on the polarity of the injected compound; flow 1 mL/min; temperature: 25° C.; injection 20 pL; detection at 686 nm, bw 20 nm.

The data relating to compounds 1-5 compared against the data of derivatives of analogous classes are shown in table II. This table shows how insignificant are the loss of titre values (%) or purity values (expresses in % area) comparable to the precision of the analytical method employed; generally for the HPLC method, a reproducibility, expressed as coefficient of variation CV % on the peak area values, of ≦ to 2% is deemed acceptable for the loss in titre and of ≦ to 0.1% for the loss of purity.

TABLE II
Stability of compounds 1-5 in deionised water in comparison with
derivatives belonging to other classes

| Com- | | Loss of | Loss of purity |
|---|---|---|---|
| pound | Structure | titre (%) | (% area) |
| 1 | 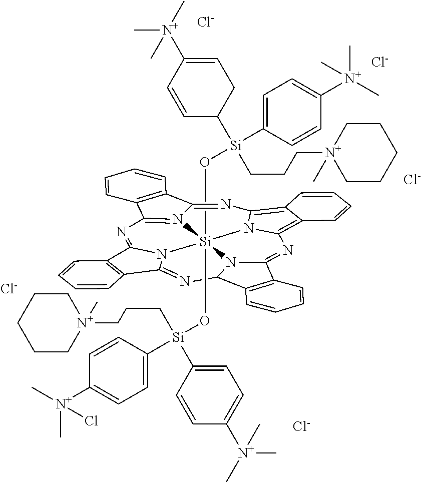 | insig- nificant | insignificant |
| 2 | 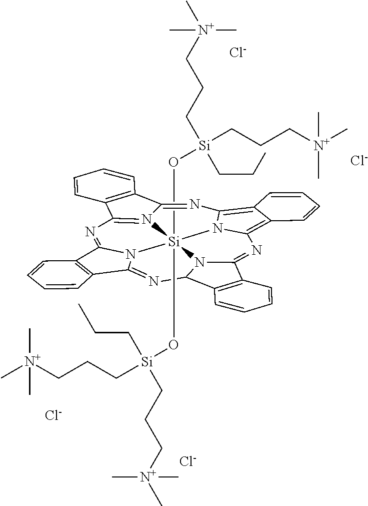 | insig- nificant | insignificant |
| 3 | 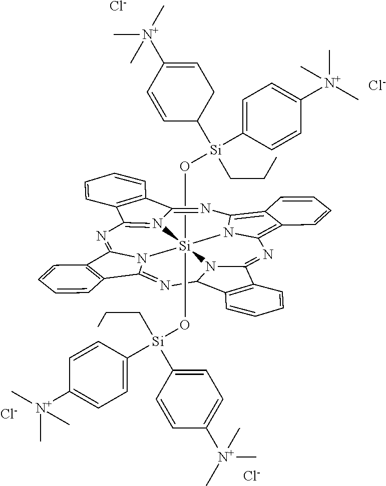 | insig- nificant | insignificant |
| 4 | 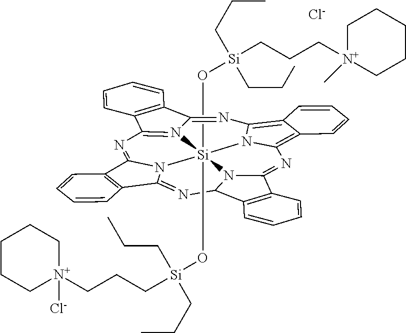 | insig- nificant | insignificant |
| 5 | 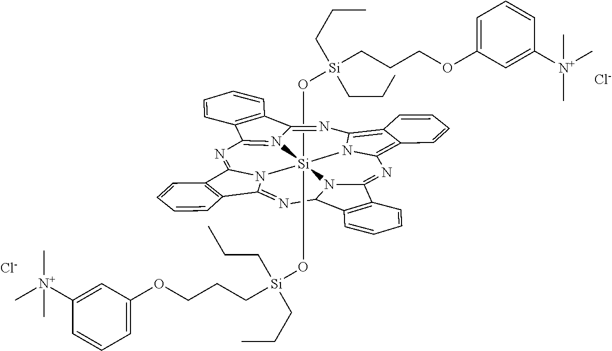 | insig- nificant | insignificant |
| Pc 4 | 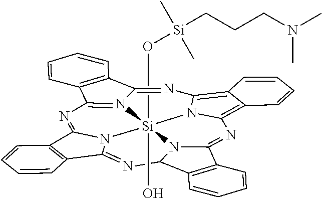 | n.a* | n.a* |

*Data not available, since the aqueous solution precipitates in a perceptible manner at the level of visual inspection in a matter of a few minutes.

| Com- | | Loss of | Loss of purity |
|---|---|---|---|
| pound | Structure | titre (%) | (% area) |
| Kenney- like 1 | 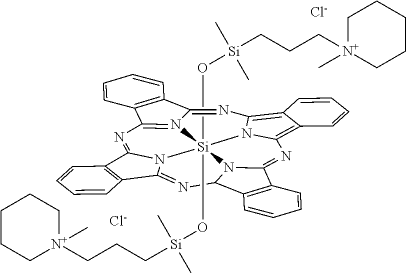 | 4.6 | 1.42 |
| Kenney- like 2 | 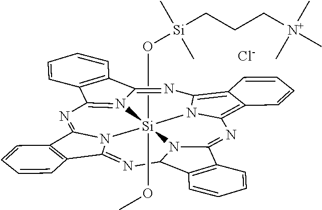 | 15.6 | 2.8 |
| Kenney- like 3 | 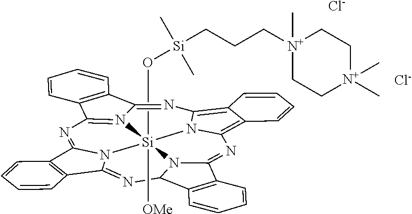 | 14.6 | 10.9 |
| Kenney- like 4 | 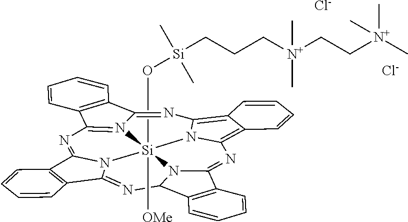 | 13.8 | 9.5 |
| Kenney- like 5 | 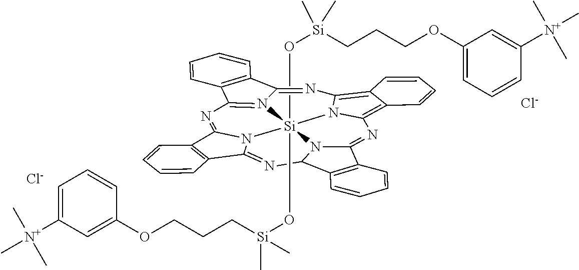 | 2.7 | 0.34 |
| Ng- like 1 | 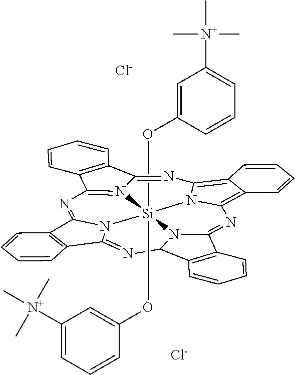 | 26.8 | 6.8 |
| Ng- like 2 | 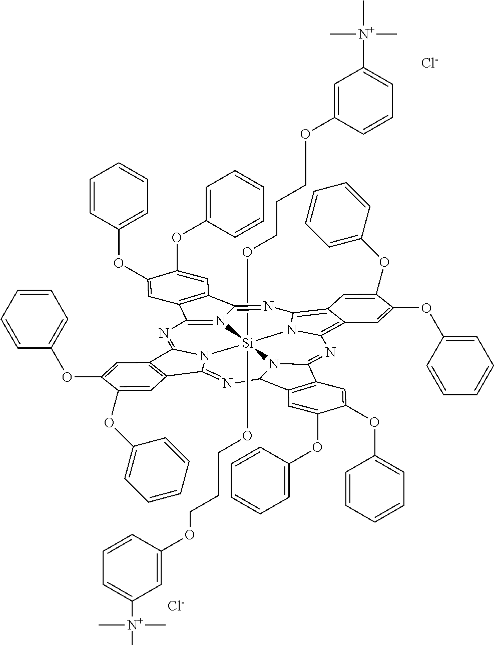 | 5.5 | 3.3 |

Unlike the Kenney- or Ng-like derivatives, which present precipitation and/or degradation phenomena, the claimed compounds in aqueous solution are stable over time and can therefore be used in therapy.

It should be noted that the stability of the aqueous solutions of Pc4 cannot be determined as the compound is not soluble at the concentrations tested.

### Example VIII

### In Vitro Evaluation of the Photodynamic Activity of the Compounds of Formula (I)

### Standard Protocol for the Antimicrobial Activity Assay

### Preparation of the Cellular Suspension

The bacterial and fungal cells (ATCC of Staphylococcus aureus, Escherichia coli and Pseudomonas aeruginosa strains for the bacteria, Candida albicans for the yeasts) are grown in a Tryptic Soy Broth (TSB) liquid medium at 37° C. for 16-20 hr (bacteria) and in Sabouraud Dextrose Broth (SDB) at 37° C. for 24 hr (yeasts) in an aerobic atmosphere.

The cells are collected for centrifugation (2000 g, 15 min.) and re-suspended in sterile PBS (pH=7.3±0.1). The final suspension is then diluted in the same tampon to obtain an absorbancy at 650 nm of around 0.7 (optical path of 1 cm), corresponding to a concentration of 10⁸-10⁹ cell/m for the bacteria and of 10⁶ cell/mL for the yeasts.

### Exposure of the Microorganisms to the Photosensitising Agent and to the Light Source

The compounds being researched are assayed in the 50-0.78 pM concentration range (for S. aureus, normally more susceptible, lower concentrations of up to 0.025 pM are also assayed). Exposure of the microorganisms to the photosensitiser and to the light source is carried out in wells of sterile, polystyrene, Microtiter plates, in PBS containing the desired concentration of photosensitiser. The plate is left to incubate at room temperature, for 5 min for the bacteria and for 1 hr at 37° C. for the yeasts. For lighting with red visible light a halogen lamp is used, model PDT 1200 Waldmann (A=600-700 nm) at 50 mW/cm² for 10 min and the total dose of light consequently used in the assay is of 30 J/cm².

Experiments are carried out for each compound in the absence of illumination to check for the presence of an intrinsic toxicity (in the dark) of the photosensitisers.

### Determination of the Antimicrobial Activity

After illuminating the bacterial or fungal suspension, and suitable dilutions thereof in sterile PBS, they are inoculated on agar plates to determine the number of residual UFCs. The plates are incubated at 37° C. for 24 hours and the results are recorded at the end of this period.

The biocidal activity of the various compounds is expressed as minimum bactericidal concentration (MBC), which reduces by 99.9%, or fungicidal concentration (MFC), which again reduced by 99.9% the untreated control inoculum (Table III).

TABLE III
In vitro antimicrobial photodynamic activity of compounds 1-5

| | MFC or MBC, 3 log (μM) | | | |
|---|---|---|---|---|
| Compound | C. albicans | S. aureus | E. coli | P. aeruginosa |
| 1 | 12.5 | 0.78 | 6.25 | 6.25 |
| 2 | >50 | 0.25 | 6.25 | 6.25 |
| 3 | >50 | 0.05 | 3.13 | 1.56 |
| 4 | 3.13* | 0.03 | 6.25 | 50 |
| 5 | 50 | 0.1 | 25 | 25 |

*For this compound an activity in the dark at a concentration of 6.25 (μM) was recorded in respect of yeasts.

No intrinsic toxicity was found for the assayed compounds in the assayed concentration range (with the exception of compound 4 in respect of yeasts) and therefore an activity of this type can only be highlighted at concentrations of >50 pM. The claimed compounds show a wide spectrum of photodynamic, antimicrobial activity that is obtainable, in the case of gram positive bacteria, at very low concentrations (nanomolar).

1. Phthalocyanine derivatives of formula (I) 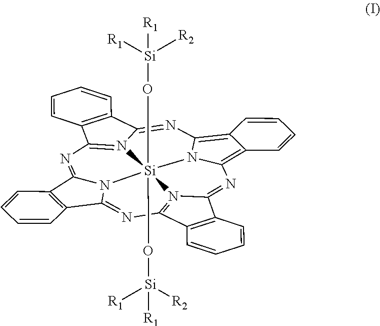
wherein
R₁=(CH₂)ₙ—CH₃ or X—Y—N⁺R₃R₄R₅;
R₂=(CH₂)ₙ—CH₃ or X₁—Y₁—N⁺R₆R₇R₈;
n=1, 2, 3, 4, 5
X and X₁ equal or different from each other are: phenyl or (CH₂)ₘ where m=1, 2, 3, 4, 5
Y and Y₁ equal or different from each other are:—(O)_{q}—W where W=phenyl or (CH₂)ₚ where q=0, 1 and p=1, 2, 3, 4, 5
R₃ and R₆ equal or different from each other are Me or Et
R₄, R₅, R₇ and R₈ equal or different from each other are Me or Et, or they form with the nitrogen atom to which they are bound a heterocycle selected from morpholine, piperidine, pyridine, pyrimidine, piperazine, pyrrolidine, pyrroline, imidazole and julolidine;
with the provision that:
R₁ and R₂ cannot be simultaneously (CH₂)ₙ—CH₃.

2. Compounds of formula (I) according to claim 1, wherein:
R₁=X—Y—N⁺R₃R₄R₅
R₂=(CH₂)ₙ—CH₃
and those wherein:
R₁=X—Y—N⁺R₃R₄R₅
R₂=X₁—Y₁—N⁺R₆R₇R₈
where n, R₁, R₂, R₃R₄, R₅, R₆, R₇, R₈, X, Y, X₁, Y₁ are as defined above.

3. Compounds of formula (I) according to claim 1 selected from:
{bis-[bis-(p-N,N,N-trimethylammoniumphenyl)]-3-(N-methyl-piperidin-1-ium)propylsilyloxy}silicon(IV) phthalocyanine hexchloride;
{bis-[bis-(3-N,N,N-trimethylammoniumpropyl)]propylsilyloxy}silicon(IV) phthalocyanine tetrachloride;
{bis-[bis-(p-N,N,N-trimethylammoniumphenyl)]propylsilyloxy}silicon(IV) phthalocyanine tetrachloride;
{bis-[3-(N-methyl-piperidin-1-ium)propyl-dipropylsilyloxy]}silicon(IV) phthalocyanine dichloride;
{bis-[3-(m-N,N,N-trimethylammoniumphenyloxy)propyl-dipropylsilyloxy]}silicon(IV) phthalocyanine dichloride;
{bis-[bis-2-(N,N-dimethyl-pyrrolidin-2-ium)ethyl]propylsilyloxy}silicon(IV) phthalocyanine tetrachloride;
{bis-[bis-2-(N,N-dimethyl-pyrrolidin-2-ium)ethyl]ethylsilyloxy}silicon(IV) phthalocyanine tetrachloride;
{bis-[bis-(N,N-dimethyl-piperidin-3-ium)methyl]propylsilyloxy}silicon(IV) phthalocyanine tetrachloride;
{bis-[bis-3-(N-methyl-piperidin-1-ium)propyl]propylsilyloxy}silicon(IV) phthalocyanine tetrachloride;
{bis-[bis-3-(N-methyl-piperidin-1-ium)propyl]butylsilyloxy}silicon(IV) phthalocyanine tetrachloride;
{bis-[bis-2-(N-methyl-pyrrolidin-1-ium)ethyl]propylsilyloxy}silicon(IV) phthalocyanine tetrachloride;
{bis-[bis-2-(N-methyl-pyrrolidin-1-ium)ethyl]ethylsilyloxy}silicon(IV) phthalocyanine tetrachloride;
{bis-[bis-(p-N,N,N-trimethylammoniumphenyl)]-2-(N,N-dimethyl-pyrrolidin-2-ium)ethylsilyloxy}silicon(IV) phthalocyanine hexachloride;
{bis-[bis-(p-N,N,N-trimethylammoniumphenyl)]-(N,N-dimethyl-piperidin-3-ium)methylsilyloxy}silicon(IV) phthalocyanine hexachloride;

4. A process for preparing compounds of formula (I) according to claim 1, wherein:
a) the amino groups-substituted trialkylmethoxysilane to be used as a reagent for inserting the axial substituents of phthalocyanine derivative, is prepared;
b) axial substituents with amino groups are inserted on the phthalocyanine core;
c) each amino substituent is quaternized by treatment with alkylating agents and ion exchange to give the final quaternary ammonium salt in the form of chloride.

5. Pharmaceutical compositions and medical devices comprising a phthalocyanine derivative of formula (I) according to claim 1 as an active ingredient/main component.

6. Use of the compounds of formula (I) according to claim 1 for preparing pharmaceutical compositions or medical devices for treating by means of photodynamic therapy diseases characterized by cellular hyperproliferation, of microbial infections caused by Gram− bacteria, Gram+ bacteria and fungi, for treating various type of infected and non-infected ulcers.
